(19) United States
(12) Patent Application Publication
(10) Pub. No.: US 2004/0177289 A1
(43) Pub. Date: Sep. 9, 2004

(54) Method and arrangement for detecting and correcting line defects

(76) Inventor: Pavel Peleska, Grafelfing (DE)

Correspondence Address: MORRISON & FOERSTER LLP, 1650 TYSONS BOULEVARD, SUITE 300, MCLEAN, VA, 22102, US

(21) Appl. No.: 10/647,651

(22) Filed: Aug. 26, 2003

(30) Foreign Application Priority Data
Aug. 27, 2002 (EP) 02019240.7

(51) Int. Cl. H04L 1/22

(52) U.S. Cl. 714/43

(57) ABSTRACT

A detection and correction method for detecting and correcting line defects, as well as a circuit arrangement, are provided to execute a checking routine on every single line, whereby all errors are reliably detected. By virtue of the detection, only one additional fallback line need be provided for each single line error to be corrected, to which fallback line a switchover is made in the event of an error.

This application claims priority to European application EP 02019240.7, which was filed in the German language on Aug. 27, 2002, the contents of which are hereby incorporated by reference.

### TECHNICAL FIELD OF THE INVENTION

The invention relates to a system and method for detecting and correcting line defects.

### BACKGROUND OF THE INVENTION

In a fault-tolerant system, for example in a telecommunications switching system, single or multiple line faults between two assemblies, modules or circuits should not lead to a system failure. In addition, it should be possible with minimal outlay to detect or repair a single line fault, or to change over to a fallback line, without impairing the redundancy of the system, its functionality or performance.

One known method of detecting single line faults provides for the use of error-correcting codes (ECC). These codes require considerable implementation effort (logic) and require a significant number of redundant signals. For instance, for a bus having a width of 64 bits, an 8-bit ECC is required to correct a single bit error. A significant amount of time is required for evaluating the ECC, which reduces the achievable performance.

### SUMMARY OF THE INVENTION

According to one embodiment of the present invention, there is a method for detecting faults in connections which connect a first module and a second module. The first and the second module may be integrated circuits IC, for example. The first and the second module may be located in a single assembly or in different assemblies. The invention is characterized in that, following an event initiating the detection method, one of the modules is determined as initiator and one of the modules as responder, and the detection method is performed, such that

the initiator sends a first value and then sends a second value to the responder over the connection, wherein the sequence first value→second value as well as the first and second value are known to the responder as a first expected sequence,

the responder checks whether the values received match the first expected sequence,

if the check by the responder was successful, the responder sends a third value and then sends a fourth value to the initiator over the connection, wherein the sequence third value→fourth value as well as the third and fourth value are known to the initiator as a second expected sequence,

if the check by the responder has a negative outcome, the responder sends the fourth value and sends the third value to the initiator over the connection and the connection is marked as faulty,

the initiator checks whether the values received in the third and fourth sequence match the second expected sequence,

if the check by the initiator was successful, the initiator sends a fifth value and then sends a sixth value to the responder over the connection, wherein the sequence fifth value→sixth value as well as the fifth and sixth value are known to the responder as a third expected sequence,

if the check by the initiator has a negative outcome, the initiator sends the sixth value and then sends the fifth value to the responder over the connection and the connection is marked as faulty,

the responder checks whether the values received in the fifth and sixth sequence match the third expected sequence, and the connection is marked as faulty if this check has a negative outcome.

One advantage of the invention is that the detection requires only minor outlay for circuitry and comprises only a few steps, i.e. a maximum of 6 steps. This is a significant advantage, for example in comparison with the known ECC which requires costly additional logic and the evaluation of which can require a significant amount of time.

If the connection is a bus formed by a plurality of binary or digital lines, that is to say is an n-bit bus, the detection method according to the invention can detect any number of simultaneously occurring bit errors. This is also an advantage in comparison with conventional ECC methods that, owing to the fundamental way they operate, only detect and/or correct a limited number of errors.

If the detection method is performed for all lines simultaneously, likewise a maximum of 6 steps are required to test all lines.

According to the invention, by virtue of the reliable detection, a single fallback line suffices to correct a single bit error. By the provision of m fallback lines, m faulty lines can be handled by the present invention.

The invention may be implemented in, for example, an application specific integrated circuit (ASIC) or a field programmable gate array (FPGA) or another integrated circuit IC with a few gates. By virtue of the static multiplexers instead of deep logic, no impairment to performance arises. Directly after faulty lines have been identified, it is possible to switch over to a fallback line without delay. The function of the circuit arrangement according to the invention is transparent for the logical operation of the module or assembly, that is to say no changes need be made to the actual logic of the module or assembly since the changes affect only the interface unit.

### BRIEF DESCRIPTION OF THE DRAWINGS

The invention will be explained in greater detail below as an exemplary embodiment with reference to the figures, in which:

FIG. 1A illustrates a connection between two integrated circuits by means of a 4-bit bus and one fallback line.

FIG. 1B illustrates a connection between two assemblies including integrated circuits by means of a 4-bit bus and one fallback line.

FIG. 2 shows a detection method according to the invention in fault-free mode.

FIGS. 3 to 7 show a detection method according to the invention in fault-free mode for various faults.

FIG. 8 shows an integrated circuit having a circuit arrangement for detecting and correcting faults.

### DETAILED DESCRIPTION OF THE INVENTION

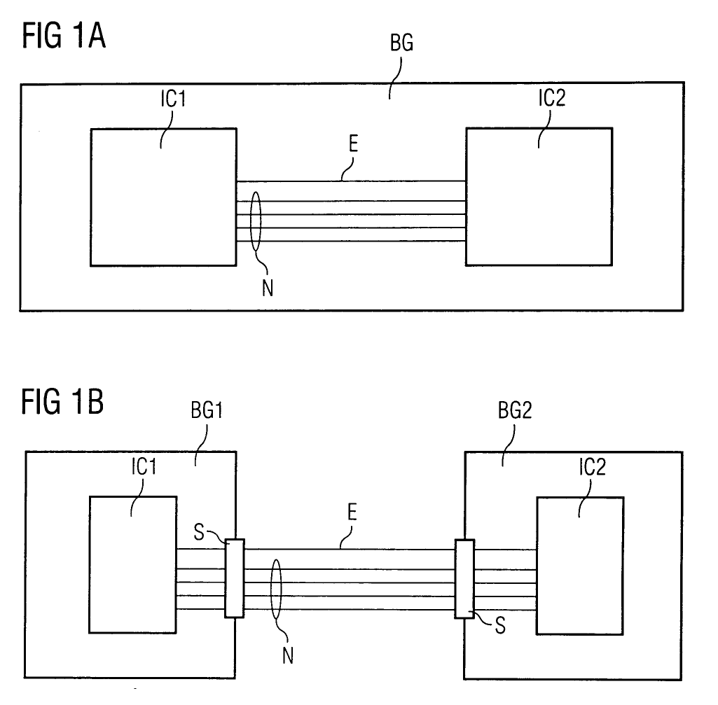

FIGS. 1A and 1B illustrate typical applications of the invention by way of example. FIG. 1A shows a first module IC1 and a second module IC2 which are connected to one another. The connection between the modules IC1, IC2 is formed by four service lines N or a 4-bit bus respectively and is extended according to the invention by a fallback line E. The figures show the modules IC1, IC2 located in one assembly. Lines N, E may be, for example, conductor tracks of a printed circuit board. Modules IC1, IC2 may be integrated circuits IC, for example.

In contrast to the situation in FIG. 1A, in FIG. 1B the modules IC1, IC2 are located in different assemblies BG1, BG2. This requires, for example, a central board on which the two assemblies BG1, BG2 are mounted with plug connections S. The assemblies BG1, BG2 and the central board in turn have the four service lines N of the 4-bit bus and the fallback line E according to the invention.

Instead of the four service lines N, which form the 4-bit bus, described by way of example, any number of service lines forming a bus of a corresponding width can be used. Likewise, with respect to the number of fallback lines, restrictions typically fall in the form of economic ones. In the present invention, the number of fallback lines is likewise unlimited and may be defined in accordance with a specifiable ratio of fallback lines to service lines, e.g. one fallback line E per four service lines N, in order to be able to handle the more likely case of a plurality of simultaneously occurring faults if many service lines are used.

The interface between the modules IC1, IC2 in FIG. 1 is preferably a synchronous bidirectional interface. Following a defined event, which is detected by both modules IC1, IC2 at the same time or in the same clock cycle, the checking of lines commences. According to one embodiment, not only the service lines N, but also the fallback lines E are checked. The event that triggers the checking may be, for example, the activation or the deactivation of a reset signal, or the transmission of a start pattern, or the reaching of a program step, or the reaching of a given clock cycle (for example checking starts at every thousandth clock cycle).

One of the modules IC1, IC2 acts as initiator and the other module IC1, IC2 acts as responder. The mechanism used to allocate the roles (initiator or responder) is of secondary importance here. For example, it could be a static, administrative definition, or a mounting location-dependent definition, or a signal via a separate connection of the modules, or a signal by means of a protocol over existing connections of the modules. It should be noted here that it is not necessary for both modules IC1, IC2 to detect the activation point. It suffices if the initiator defined clearly using one of the methods stated detects the event for starting the checking and signals the start of checking to the responder in an appropriate manner. This can also be accomplished by means of a test pattern sent by the initiator to the responder, in which case however, in addition to the measures set out below, it is necessary to make provision for the case where the responder cannot detect the test pattern due to an error and does not switch over to the checking mode and the responder mode.

The following faults can occur and are reliably detected by the detection method according to the invention:

The line between the modules IC1, IC2 is interrupted or short-circuited (“stuck-at fault”), for example as a result of a defect on the bond wire, at the soldering point of one of the modules, of a conductor track of the assemblies BG, BG1, BG2, at the plug contact S between the assemblies, or between the assemblies and the central board or backplane, of the contact at the socket or of a conductor track of the central board or backplane.

The sender of the interface driver or interface buffer of one of the modules or both modules IC1, IC2 is not supplying a correct level.

The receiver of the interface driver or interface buffer of one of the modules or both modules IC1, IC2 is not detecting a correct level.

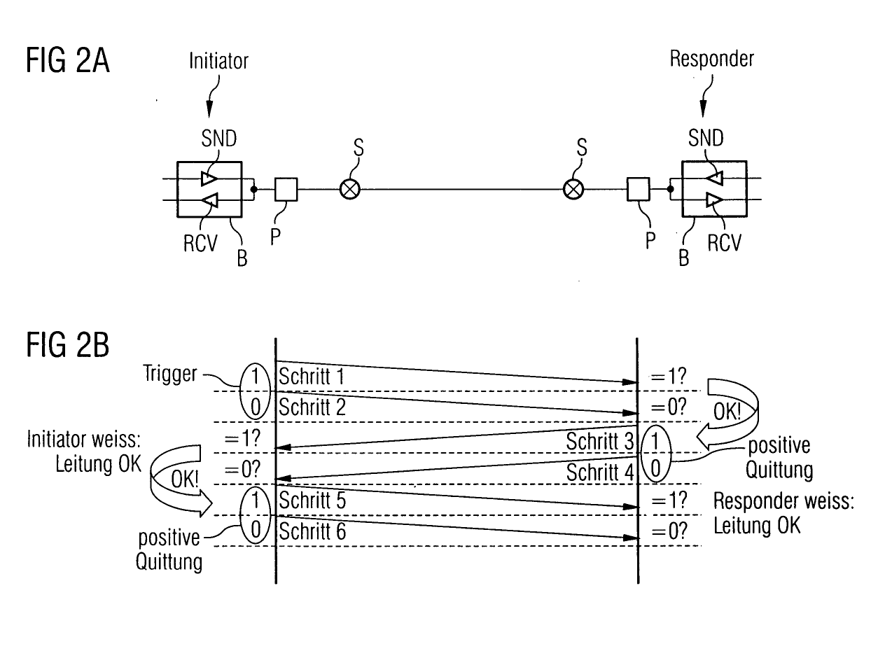

The fault-free case will be described below with reference to FIG. 2. FIG. 2A illustrates a service line N or a fallback line E which forms the connection to be tested, together with in each case an interface buffer or I/O buffer B of the initiator and of the responder, with the pin or pad or ball respectively of the module IC1, IC2 including the initiator or responder in each case, which pin/pad/ball is connected to the I/O buffer B in each case, and with the plug contacts S. It should be noted that no plug contacts are present for a simpler arrangement according to FIG. 1A. It should also be noted that the connection to be tested may be divided into a plurality of physically separate sections:

Bond wires between the I/O buffers B and the pins/pads/balls P,

Conductor tracks on the assemblies BG1, BG2, arranged between the pins/pads/balls P and the plug contacts S,

Conductor tracks on the central board, arranged between the plug contacts S.

Finally, it should be noted that the I/O buffer B comprises a sender SND and a receiver RCV in each case.

FIG. 2B shows the sequence of the detection method according to the invention for the fault-free case, that is to say none of the aforesaid components and sections of the connection have defects. In step 1 a logical “1” is sent from the initiator to the responder, and in step 2 a logical “0” is sent from the initiator to the responder. This changeover at least once from “1” and “0” serves to detect stuck-at faults, that is to say errors resulting from short-circuits of the connection to be tested with “1” or “0”. The order or sequence (“1”→“0” or “0”→“1”) does not matter here, but this first sequence for the connection to be tested is known to the initiator and to the responder.

The values received by the responder are checked by the responder. In the fault-free case the values “1” and “0” are received in the correct sequence by the responder, whereupon the latter sends a “1” in step 3 and a “0” in step 4 to the initiator. Besides the actual function of this sequence which includes testing the elements of the connection in the other direction, this second sequence serves to signal to the initiator that the first sequence has been received error-free (positive acknowledgment). Again the sequence “1”→“0” for the second sequence is simply by way of example.

The values received by the initiator are checked by the initiator. In the fault-free case the values “1” and “0” are received in the correct sequence by the initiator, whereupon the latter sends a “1” in step 5 and a “0” in step 6 to the responder. Reception of the values in the correct sequence simultaneously signifies to the initiator that the elements of the connection are operating without errors in both directions, the initiator now “knows” that the connection is fault-free. If necessary, this knowledge is stored in a suitable memory register and/or forwarded to an evaluation logic means of the integrated circuit IC1, IC2 of which the initiator is a part (not illustrated).

In step 5, the initiator sends a “1”]and in step 6 sends a “0” to the responder (third sequence) to signal that from its point of view the connection is fault-free (positive acknowledgment). The values received by the responder are checked by the responder. In the fault-free case the values “1” and “0” are received in the correct sequence by the responder, whereupon the latter “knows” that the connection is OK. If necessary, this knowledge is stored in a suitable memory register and/or forwarded to an evaluation logic means of the integrated circuit IC1, IC2 of which the responder is a part (not illustrated).

In another embodiment of the invention, the first sequence (steps 1 and 2) may serve as a trigger that the initiator uses to signal the beginning of checking to the responder. A longer sequence not occurring otherwise during operation may be required for this. The measures to be taken are known to persons skilled in the art and are not described here.

Longer sequences may of course be used to check the connection and detect errors. For example, instead of the described sequence “10”, a sequence “101010” may be used in order to be able to detect, in addition to the detectable static errors, also dynamic errors that occur during rapid level changes. If adjacent conductor tracks are to be checked for crosstalk, in another embodiment an appropriate coordination by means of a control logic means which controls the checking method is necessary, which coordination ensures that different levels occur at the same time on adjacent conductor tracks. A large number of such further developments exist and are obvious to persons skilled in the art even without being explicitly mentioned herein.

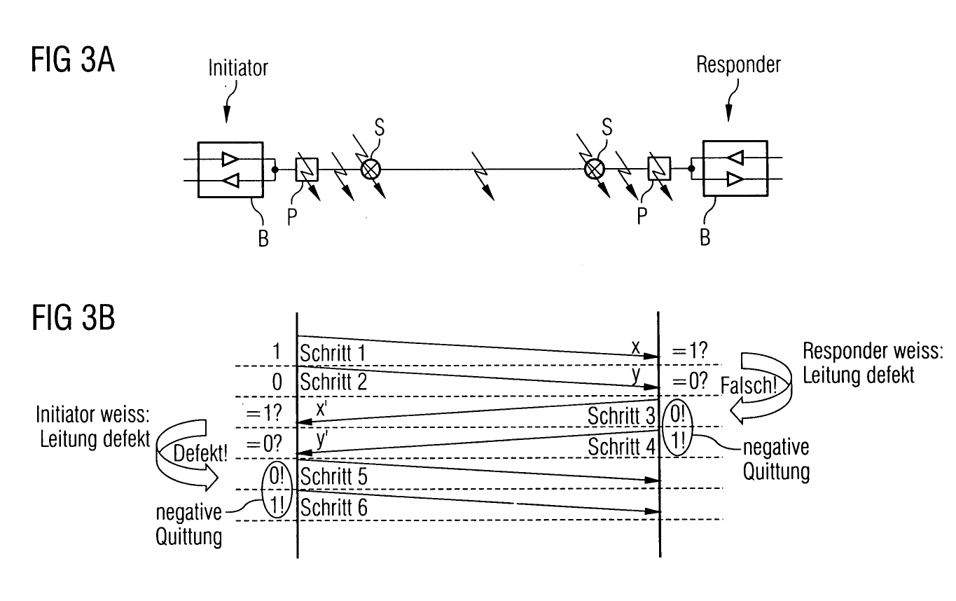

The case of a line fault in one of the aforesaid sections will now be described with reference to FIG. 3. FIG. 3A indicates the possible faults by means of arrows. In terms of their effects, the faults are equivalent for the checking method according to the invention. Possible faults are: defective bond wire in the IC, a damaged soldering point at the pin/pad/ball P, a defective connector pin S or an interrupted line on the assembly or the backplane. In each case the fault may signify an interruption or a short-circuit (“stuck-at fault”).

FIG. 3B illustrates the sequence of the checking method for the fault case in FIG. 3A. The sequences sent in steps 1-6 correspond to those stated in relation to FIG. 2. To avoid repetition, only the differences to FIG. 2 will be described here.

Depending on the type of error (interruption, stuck-at-1 or stuck-at-0), the receiver RCV of the responder will not detect a “1” in step 1 and/or a “0” in step 2. The responder therefore “knows” that a defect is present and sends a negative acknowledgment in steps 3 and 4, and sends the sequence “01” instead of the sequence “10”. Since the line is interrupted or short-circuited, the initiator will not receive the negative acknowledgment, but in steps 3 and 4 it will clock in a sequence that does not correspond to the positive acknowledgment “10”. The initiator consequently detects that the line is defective. The initiator then likewise sends a negative acknowledgment, here the sequence “01” instead of the sequence “10”, in steps 5 and 6. This is necessary because the initiator cannot differentiate between an actual line defect and a defect at the sender of the responder, and in the latter case the responder must be notified.

Both in the initiator and in the receiver, the knowledge about the defect is suitably processed and/or forwarded and/or stored in a memory.

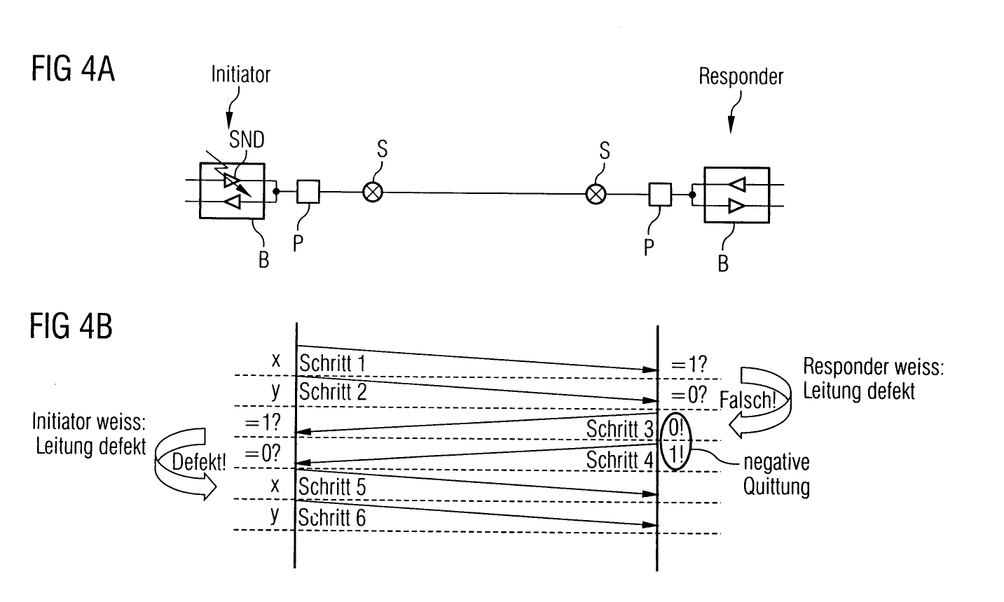

The case of a fault in the driver element or sender element SND in the initiator will now be described with reference to FIG. 4. FIG. 4A indicates the fault by means of an arrow.

FIG. 4B illustrates the sequence of the checking method for the fault case in FIG. 4A. The sequences sent in steps 1-6 correspond to those stated in relation to FIG. 2. Again, only the differences to FIG. 2 will be described.

The receiver of the responder will not detect a “1” in step 1 and/or a “0” in step 2. The responder therefore “knows” that a defect is present and sends a negative acknowledgment in steps 3 and 4, and sends the sequence “01” instead of the sequence “10”. The initiator receives the negative acknowledgment and therefore “knows” that a fault is present. The initiator then likewise attempts to send a negative acknowledgment, here the sequence “01” instead of the sequence “10”, in steps 5 and 6. Owing to the defective driver element, however, this is not successful. In this case, too, both the initiator and the responder “know” that a fault is present and process this information accordingly.

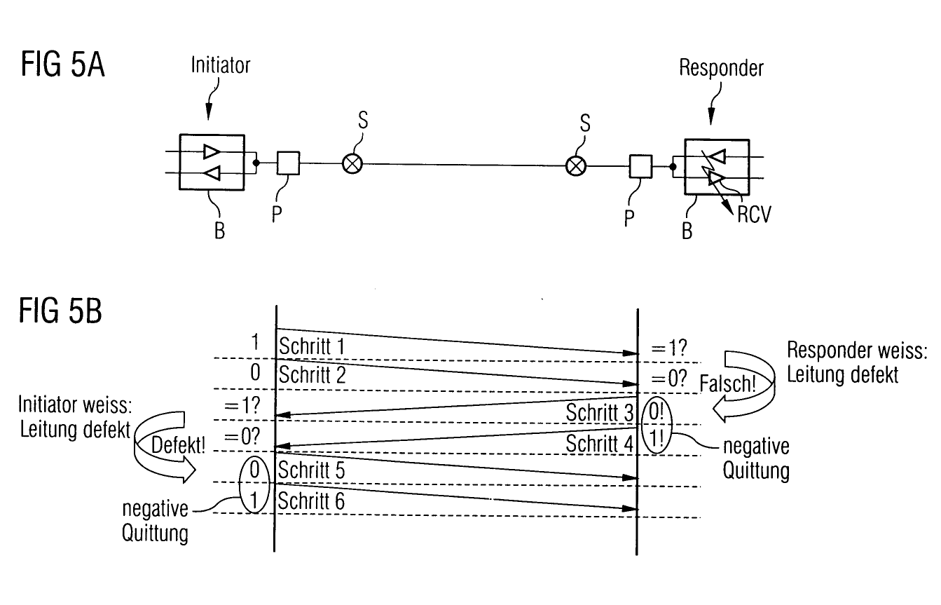

The case of a fault in the receiver element RCV in the responder will now be described with reference to FIG. 5. FIG. 5A indicates the fault by means of an arrow. FIG. 5B illustrates the sequence of the checking method for the fault case in FIG. 5A. The sequences sent in steps 1-6 correspond to those stated in relation to FIG. 2.

The receiver of the responder will not detect a “1” in step 1 and/or a “0” in step 2. The responder therefore “knows” that a defect is present and sends a negative acknowledgment in steps 3 and 4, and sends the sequence “01” instead of the sequence “10”. The initiator receives the negative acknowledgment and therefore “knows” that a fault is present. The initiator then likewise sends a negative acknowledgment, here the sequence “01” instead of the sequence “10”, in steps 5 and 6. Owing to the defective receiver element, however, this is not correctly received either. In this case, too, both the initiator and the responder know that a fault is present and process this information accordingly.

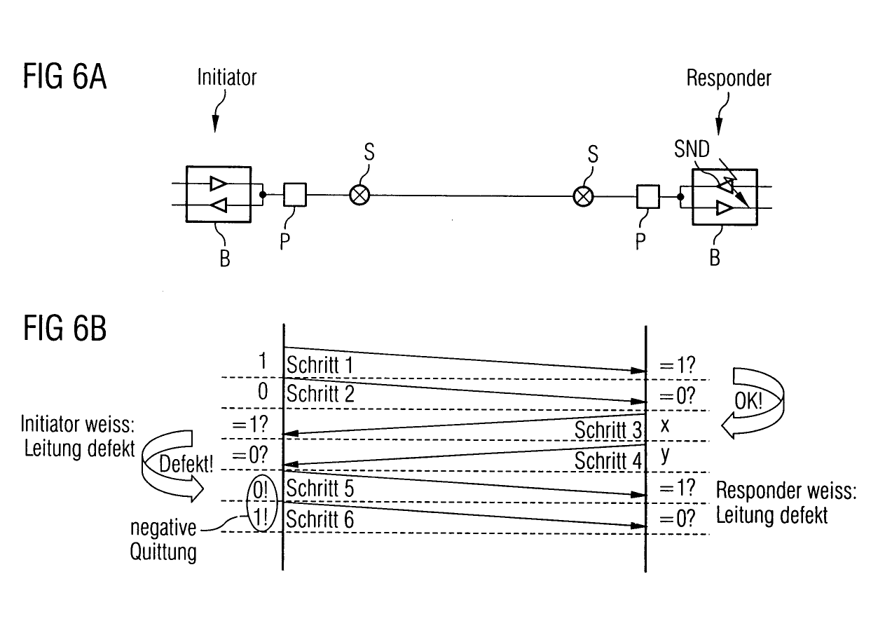

The case of a fault in the driver element or sender element SND in the responder will now be described with reference to FIG. 6. FIG. 6A indicates the fault by means of an arrow.

FIG. 6B illustrates the sequence of the checking method for the fault case in FIG. 6A. The sequences sent in steps 1-6 correspond to those stated in relation to FIG. 2.

The receiver of the responder receives a “1” in step 1 and a “0” in step 2. From the point of view of the responder, the connection is therefore fault-free, whereupon in steps 3 and 4 the responder sends a positive acknowledgment, the sequence “10” for the exemplary embodiment described. However, the initiator does not receive the positive acknowledgment correctly and therefore “knows” that a fault is present. The initiator then sends a negative acknowledgment, here the sequence “01” instead of the sequence “10”, in steps 5 and 6. This is received correctly by the responder, with the result that the responder now also “knows” that an error is present. In this case, too, both the initiator and the responder “know” that a fault is present and process this information accordingly.

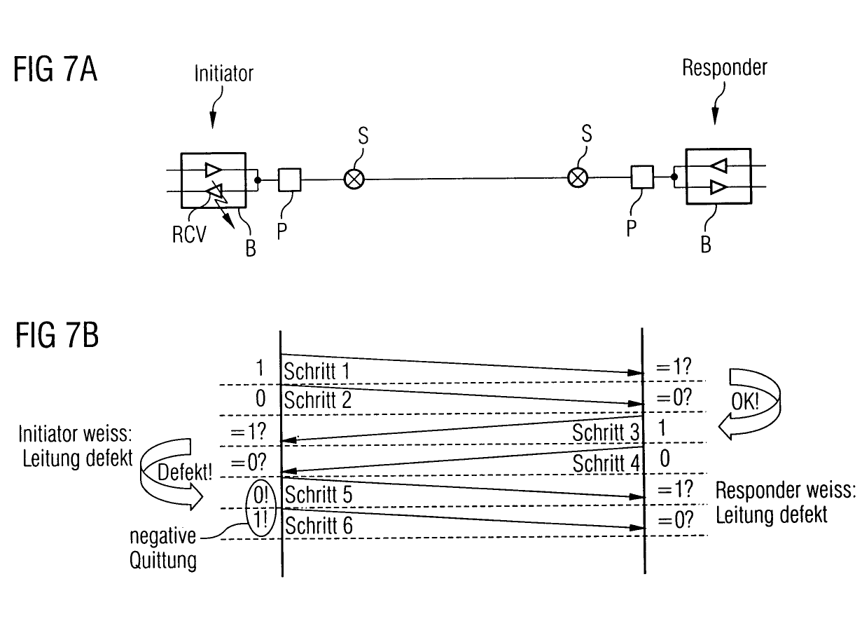

The case of a fault in the receiver element RCV in the initiator will now be described with reference to FIG. 7. FIG. 7A indicates the fault by means of an arrow. FIG. 7B illustrates the sequence of the checking method for the fault case in FIG. 7A. The sequences sent in steps 1-6 correspond to those stated in relation to FIG. 2.

The receiver of the responder receives a “1” in step 1 and a “0” in step 2. From the point of view of the responder, the connection is therefore fault-free, whereupon in steps 3 and 4 the responder sends a positive acknowledgment, in this case the sequence “10”. However, the initiator does not receive the positive acknowledgment correctly and therefore knows that a fault is present. The initiator then sends a negative acknowledgment, for the present exemplary embodiment the sequence “01” instead of the sequence “10”, in steps 5 and 6. This is received correctly by the responder, with the result that the responder now also “knows” that an error is present. In this case, too, both the initiator and the responder “know” that a fault is present and process this information accordingly.

In the aforesaid cases, a line defect is clearly detected by both the initiator and the responder, so that a fallback changeover is possible. How many fallback changeovers are possible depends on the number of fallback lines E available.

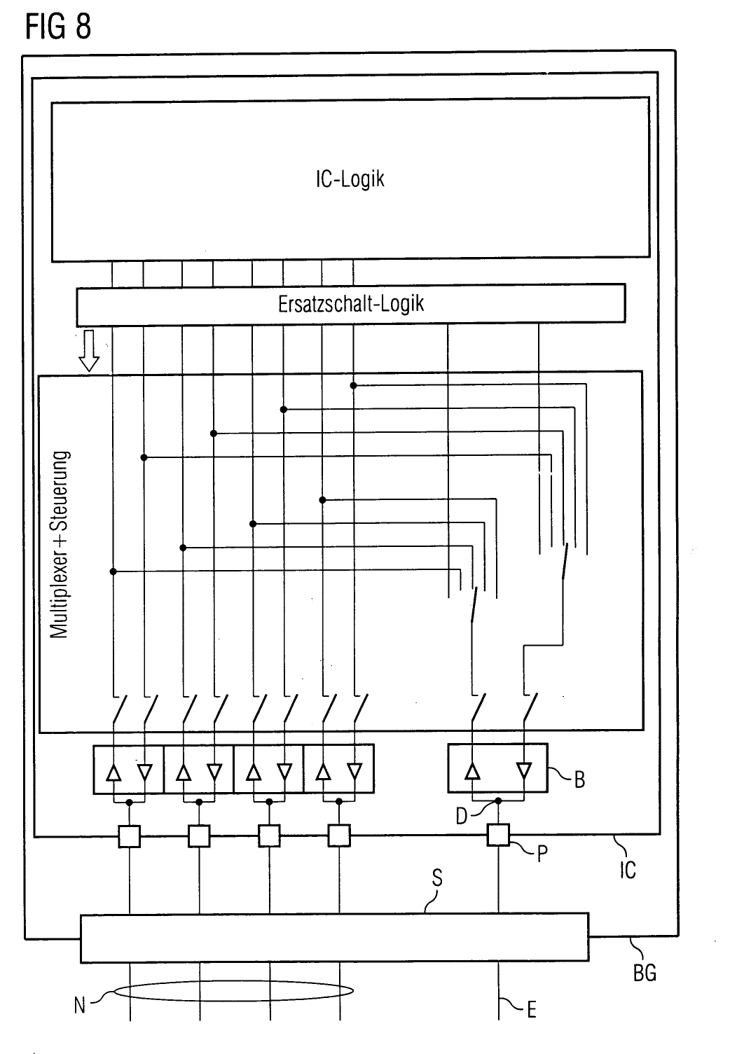

FIG. 8 shows the exemplary embodiment having a fallback line E for a 4-bit bus from FIG. 1 with further details. FIG. 8 discloses a circuit arrangement which can perform a fallback changeover in response to the detection of a line defect. A multiplexer and a controller for the supply and selection of the fallback line are shown, as well as a fallback logic means which implements the method described in connection with FIGS. 1-7 and then controls the multiplexer. The remaining IC logic is not affected by this method, so little implementation effort is required.

In alternative exemplary embodiments, other methods for detecting line defects with the circuit arrangement from FIG. 8 may be advantageously employed.

Advantageously both the service lines N of the connection to be improved as well as their fallback lines E are covered by the error detection and switchover method, since this firstly ensures that a switchover is made to another fallback line if a defect occurs on one fallback line, and secondly that switching over from a service line to a likewise defective fallback line is avoided.

If more defects than fallback lines are present, the connection has irreparably failed and appropriate actions can be initiated by the control logic means, e.g. signaling to a central alarm module of the assembly, output of a signal at a diagnostic pin, switchover to a redundant assembly or a redundant system etc. Such error handling mechanisms for self-diagnosed failures are well-known in the art and may be applied in connection with the present invention.

As already indicated, in a further development it is possible to detect fault cases that can occur on directly adjacent pins of a module IC1, IC2. The pins are usually connected to adjacent lines of the circuit board, the backplane and/or pins of the connector. For this, the above method is used with an inverted level for every second pin in order to detect also any short circuits between adjacent pins or lines.

A step 1-6 may correspond to one cycle of the synchronous interface, the checking and fallback changeover would thus be performed already after 6 cycles. Depending on the sender/receiver technology used, for example with CMOS totem pole, it may be necessary to insert an empty cycle, a so-called “turnaround cycle”, between step 2 and step 3 as well as between step 4 and step 5 to prevent driver conflicts. In this case, the method requires a total of 8 cycles. With a GTL interface, for example, the turnaround cycles are not required as in this case the checking method completes execution after 6 cycles.

As already mentioned, the method described above can be extended in order to increase error detection reliability, in that the trigger (steps 1 and 2) is not only a ‘10’ sequence, but, for example, the latter is sent and expected three times by threefold repetition of steps 1 and 2, that is to say as ‘101010”. The same ‘101010’ sequence can represent the positive acknowledgment, while a ‘010101’ sequence can accordingly represent the negative acknowledgment. It is consequently also possible to detect dynamic defects.

It is furthermore possible to repeat the respective associated steps (1 and 2, 3 and 4, and 5 and 6) to form any sequences in any order. For instance, if ‘1’ is used in step 1 and ‘0’ is used in step 2, the sequence ‘100110’ can be represented as step sequence 1-2-2-1-1-2. The length of the sequences of steps 1-2, 3-4 and 5-6 is preferably equal here, but it may also be different.

FIG. 1A

FIG. 1B

Initiator weiss: Initiator knows:

Responder weiss: Responder knows:

Leitung OK line OK

positive Quittung Positive acknowledgment

Schritt Step

Defekt! Defective

negative Quittung Negative acknowledgment

Leitung defekt line defective

Falsch! Incorrect!

IC-Logik IC logic

Ersatzschalt-Logik Fallback switching logic

Multiplexer+Steuerung Multiplexer+controller

FIG. 2A

FIG. 2B

Initiator weiss: Initiator knows:

Responder weiss: Responder knows:

Leitung OK line OK

positive Quittung Positive acknowledgment

Schritt Step

FIG. 3A

FIG. 3B

Initiator weiss: Initiator knows:

Responder Weiss: Responder knows:

Schritt Step

Defekt! Defective

negative Quittung Negative acknowledgment

Leitung defekt line defective

Falsch! Incorrect!

FIG. 4A

FIG. 4B

Initiator weiss: Initiator knows:

Responder Weiss: Responder knows:

Schritt Step

Defekt! Defective

negative Quittung Negative acknowledgment

Leitung defekt line defective

Falsch! Incorrect!

FIG. 5A

FIG. 5B

Initiator weiss: Initiator knows:

Responder Weiss: Responder knows:

Schritt Step

Defekt! Defective

negative Quittung Negative acknowledgment

Leitung defekt line defective

Falsch! Incorrect!

FIG. 6A

FIG. 6B

Initiator weiss: Initiator knows:

Responder Weiss: Responder knows:

Schritt Step

Defekt! Defective

negative Quittung Negative acknowledgment

Leitung defekt line defective

FIG. 7A

FIG. 7B

Initiator weiss: Initiator knows:

Responder weiss: Responder knows:

Schritt Step

Defekt! Defective

negative Quittung Negative acknowledgment

Leitung defekt line defective

FIG. 8

IC-Logik IC logic

Ersatzschalt-Logik Fallback switching logic

Multiplexer+Steuerung Multiplexer+controller

What is claimed is:

1. A method for detecting faults in connections which connect a first module and a second module, following an event initiating the detection method, determining one of the modules as initiator and one of the modules as responder, comprising:
sending the initiator, in a first step, a first value and sending a second value, in a second step, to the responder over a connection, wherein a first sequence and the first and second value are known to the responder as a first expected sequence;
checking, via the responder, whether the values received in the first and second step match the first expected sequence;
if the check by the responder is successful, in a third step, sending, via the responder, a third value and, in a fourth step, sending a fourth value to the initiator over the connection, wherein a second sequence and the third and fourth value are known to the initiator as a second expected sequence;
if the check by the responder is a negative outcome, in the third step, sending, via the responder, the fourth value and, in the fourth step, sending the third value to the initiator over the connection and marking the connection as faulty;
checking, via the initiator, whether the values received in the third and fourth step match the second expected sequence;
if the check by the initiator is successful, sending, in a fifth step, via the initiator, a fifth value and, in a sixth step, sending a sixth value to the responder over the connection, wherein a third sequence and the fifth and sixth value are known to the responder as a third expected sequence;
if the check by the initiator is a negative outcome, sending, in the fifth step, via the initiator, the sixth value and, in the sixth step, sending the fifth value to the responder over the connection and marking the connection as faulty;
checking, via the responder, whether the values received in the fifth and sixth step match the third expected sequence, and marking the connection as faulty if the check has a negative outcome.

2. The method as claimed in claim 1, wherein the first and second, third and fourth, and fifth and sixth values are pair-wise different in each case.

3. The method as claimed in claim 1, wherein the first and the second step are repeated at least once after completion of the second step, with the first expected sequence being extended accordingly,
the third and the fourth step are repeated at least once after completion of the fourth step, with the second expected sequence being extended accordingly, and
the fifth and the sixth step are repeated at least once following the sixth step, with the third expected sequence being extended accordingly.

4. The method as claimed in claim 1, wherein one of the modules is determined as initiator and one of the modules is determined as responder by at least on of means of static, administrative definition, by mounting location-dependent definition, by a signal via a separate connection of the modules, and by a signal by means of a protocol over existing connections of the modules.

5. The method as claimed in claim 1, wherein an existing fallback connection is activated for a connection marked as faulty by a control logic device which controls the detection method.

6. The method as claimed in claim 1, wherein for detecting faults on binary connections, one of the values 0 or 1 is selected for the first, the third and the fifth value in each case, and the second value is obtained from logical inversion of the first value, the fourth value is obtained from logical inversion of the third value, and the sixth value is obtained from logical inversion of the fifth value.

7. The method as claimed in claim 6, wherein for bus connections having a width of n bits, which are formed by n binary connections, the detection method is performed for each of the n binary connections.

8. The method as claimed in claim 7, wherein for the bus connections having a width of n bits, which are formed by the n binary connections, at least one binary fallback connection is provided which is activated if one of the n binary connections is marked as faulty.

9. A method for correcting faults in connections between digital modules, comprising:
forming a connection by a first group of active connection lines and providing a second group of inactive connection lines accordingly; and
activating an inactive connection line of the second group and deactivating a connection line that has been active up until this point if the active connection line is found to be faulty by the control logic device, wherein the control logic device in cooperation with a multiplexing device controls activation and deactivation.

10. A circuit arrangement for correcting faults on connections between digital modules, comprising:
a control logic device to detect arrangement-internal and arrangement-external faults of input/output connections and a multiplexer device to switch over data transmission of faulty active input/output connections to fault-free inactive input/output connections.

11. The circuit arrangement as claimed in claim 10, wherein the control logic device has a unit which performs: sending an initiator, in a first step, a first value and sending a second value, in a second step, to a responder over a connection, wherein a first sequence and the first and second value are known to the responder as a first expected sequence;
checking, via the responder, whether the values received in the first and second step match the first expected sequence;
if the check by the responder is successful, in a third step, sending, via the responder, a third value and, in a fourth step, sending a fourth value to the initiator over the connection, wherein a second sequence and the third and fourth value are known to the initiator as a second expected sequence;
if the check by the responder is a negative outcome, in the third step, sending, via the responder, the fourth value and, in the fourth step, sending the third value to the initiator over the connection and marking the connection as faulty;
checking, via the initiator, whether the values received in the third and fourth step match the second expected sequence;
if the check by the initiator is successful, sending, in a fifth step, via the initiator, a fifth value and, in a sixth step, sending a sixth value to the responder over the connection, wherein a third sequence and the fifth and sixth value are known to the responder as a third expected sequence;
if the check by the initiator is a negative outcome, sending, in the fifth step, via the initiator, the sixth value and, in the sixth step, sending the fifth value to the responder over the connection and marking the connection as faulty;
checking, via the responder, whether the values received in the fifth and sixth step match the third expected sequence, and marking the connection as faulty if the check has a negative outcome.

12. The circuit arrangement as claimed in claim 10, wherein
the circuit arrangement is part of an integrated circuit.
